(19) United States
(12) Patent Application Publication
(10) Pub. No.: US 2025/0227639 A1
(43) Pub. Date: Jul. 10, 2025

(54) ANALYZING TIMING OF PACKETS IN FRONTHAUL

(71) Applicant: RAKUTEN SYMPHONY, INC., Tokyo (JP)

(72) Inventor: Machireddy RAMANA REDDY, Bangalore (IN)

(73) Assignee: RAKUTEN SYMPHONY, INC., Tokyo (JP)

(21) Appl. No.: 18/293,575

(22) PCT Filed: Dec. 5, 2023
(86) PCT No.: PCT/US2023/082446

§ 371 Date: Jan. 30, 2024

(51) Int. Cl. H04W 56/00; H04J 3/06

(52) U.S. Cl. CPC H04W 56/0035; H04J 3/0667

(57) ABSTRACT

Provided are a method, system, for determining at least one Open Radio Access Network (O-RAN) element which causes a timing drift in an O-RAN network. In particular, the method may include: receiving, by a radio unit (RU), at least one fronthaul (FH) packet comprising a Time of Day (TOD) from a distributed unit (DU); detecting, by the RU, a timing drift in FH based on the received at least one FH packet; and identifying, by the RU, the at least one O-RAN element causing the timing drift in FH based on detecting the timing drift.

### FIELD

System and methods consistent with example embodiments of the present disclosure relate to managing analysis of timing of packets in fronthaul networks.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical Node for hosting Radio Resource Control (RRC), Service Data Adaptation Protocol (SDAP), and/or Packet Data Convergence Protocol (PDCP) sublayers of the RAN. The DU is a logical Node hosting Radio Link Control (RLC), Media Access Control (MAC), and Physical (PHY) sublayers of the RAN. The RU is a physical Node that converts radio signals from antennas to digital signals that can be transmitted over the fronthaul to a DU. Because these entities have open protocols and interfaces between them, they can be developed by different vendors.

Evolved Common Public Radio Interface (eCPRI) is a protocol which can be used in fronthaul (FH) transport networks, particularly between the DU and the RU.

FIG. 1 illustrates an example structure of a eCPRI message according to the related art. In particular, a eCPRI common header and payload may be provided, and this may be included as part of the transport network layer payload (e.g., a transport network such as UDP/IP or Ethernet). The total size of the eCPRI message may correspond to a eCPRI protocol data unit (PDU).

### SUMMARY

Existing eCPRI protocol in fronthaul cannot carry UTC Time of Day (TOD). Accordingly, when the RU is acting as a Telecom Time Slave Clock (T-TSC) wherein it has Radio applications which require timing, the RU does not have UTC timing reference information for IQ packets with Sub-frame Number (SFN) information that is being received. Accordingly, any timing drifts which occur in fronthaul L1 packets causing counters to be incremented too early/late which may impact the cell performance and Key Performance Indicators (KPI) cannot be easily debugged/isolated as to their root cause, that is, as to whether the timing drift is caused by the DU (e.g., synchronization plane (s-plane) drift) or the RU itself (e.g., S-plane itself causing fronthaul packets to not be received on time due to timing drift).

Accordingly, there is a need for an improved way to include TOD in fronthaul packets and analyze the timing information in packets for the fronthaul network.

Example embodiments of the present disclosure provide a method and system for including TOD in fronthaul packets and analyzing the same. In particular, embodiments may include receiving, by a radio unit (RU) in an Open Radio Access Network (O-RAN) network, at least one fronthaul (FH) packet including a Time of Day (TOD) from a distributed unit (DU) in the O-RAN network; detecting, by the RU, a timing drift in fronthaul (FH) based on the received at least one FH packet; and identifying, by the RU, at least one O-RAN element in the O-RAN network causing the timing drift in FH based on detecting the timing drift.

Accordingly, embodiments may allow for analysis and debugging of timing drift issues in fronthaul packets since the RU otherwise would not typically have TOD reference for the received IQ packets from DU. This may be especially useful since in O-RAN different units (e.g., the DU and RU) may be from different vendors, so interoperability between different devices may be improved by adding the TOD to the fronthaul packets.

According to embodiment, a system which may be implemented in a radio access network (RAN) may be provided, the system may include: a radio unit (RU); a distributed unit (DU); and at least one transport network element; wherein the RU is configured to receive at least one fronthaul (FH) packet comprising a Time of Day (TOD) information from the DU, detect a timing drift in fronthaul (FH) based on the received at least one FH packet, and identify at least one of the RU, the DU, or the at least one transport network element as causing the timing drift in FH based on detecting the timing drift.

According to embodiments, a non-transitory computer-readable recording medium may be provided, the non-transitory computer-readable recording medium having recorded thereon instructions to perform a method including: receiving, by a radio unit (RU) in an Open Radio Access Network (O-RAN) network, at least one fronthaul (FH) packet comprising a Time of Day (TOD) from a distributed unit (DU) in the O-RAN network; detecting, by the RU, a timing drift in fronthaul (FH) based on the received at least one FH packet; and identifying, by the RU, at least one O-RAN element in the O-RAN network causing the timing drift in FH based on detecting the timing drift.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an eCPRI message according to the related art;

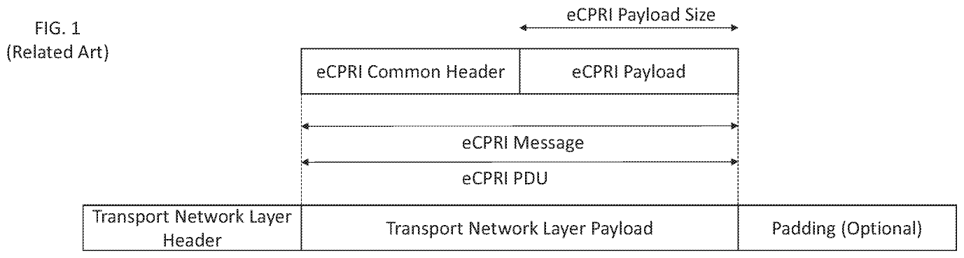

FIG. 2 illustrates an eCPRI message including Time of Day (TOD) according to an embodiment;

FIG. 3 illustrates a flowchart of a method for detecting an O-RAN element which causes timing drift according to an embodiment;

FIG. 4 illustrates a flowchart of a method for analyzing timing drift based on a sub-frame number (SFN) according to an embodiment;

FIG. 5 illustrates a flowchart of a method for detecting an O-RAN element which causes timing drift including forming of a fronthaul (FH) packet according to an embodiment;

FIG. 6 illustrates a diagram of an example environment in which systems and/or methods, described herein, may be implemented; and

FIG. 7 illustrates a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system for including TOD in fronthaul packets and analyzing the same. In particular, embodiments may include receiving, by a radio unit (RU) in an Open Radio Access Network (O-RAN) network, at least one fronthaul (FH) packet including a Time of Day (TOD) from a distributed unit (DU) in the O-RAN network; detecting, by the RU, a timing drift in fronthaul (FH) based on the received at least one FH packet; and identifying, by the RU, at least one O-RAN element in the O-RAN network causing the timing drift in FH based on detecting the timing drift.

Accordingly, embodiments may allow for analysis and debugging of timing drift issues in fronthaul packets since the RU otherwise would not typically have TOD as a reference for the received IQ packets from DU. This may be especially useful since in O-RAN different units (e.g., the DU and RU) may be from different vendors, so interoperability between different devices may be improved by adding the TOD to the fronthaul packets.

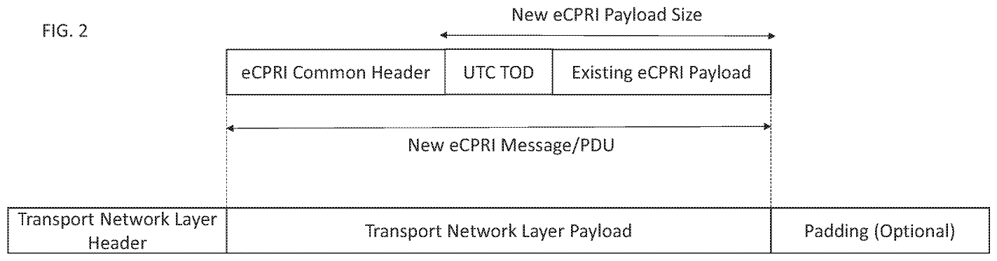

FIG. 2 illustrates an eCPRI message including Time of Day (TOD) according to an embodiment.

In particular, as illustrated in FIG. 2, a TOD may be added in UTC format (shown as “UTC TOD” in FIG. 2). Accordingly, the new eCPRI payload size would be the size of the UTC TOD combined with the existing eCPRI payload, and the size of the new eCPRI message/protocol data unit (PDU) would be the existing eCPRI common header along with the UTC TOD and existing eCPRI payload.

The size of the TOD may depend on the specific implementation. For example, 80 bits could be allocated, or any other desired number of bits (more or less) depending on the specific implementation. The TOD may be represented in seconds or nano seconds according to some embodiments.

The TOD may act as a UTC reference time as to when the fronthaul (FH) packets (which may be sent from a DU) containing IQ data are being received by the RU. Since the RU receives IQ data along with the TOD from the DU, timing drifts (e.g., packets being received too late or too early) can be seen by the RU, and issues can be analyzed by checking the Sub-Frame Number (SFN) of the FH packet and comparing it with the TOD from the same FH packet. The amount of timing drift can accordingly be determined.

For instance, if the amount of timing drift can be matched to the TOD, the timing drift can be concluded to be caused from the DU sending the FH packets. Alternatively, if the TOD matches the SFN, the issue can be concluded to being caused by a different module within the RU which is receiving the FH packets containing the IQ, and not an issue with the DU packet.

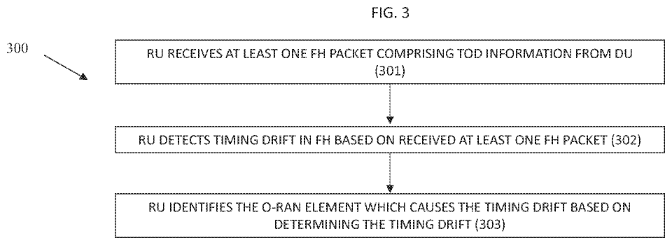

FIG. 3 illustrates a flowchart of a method 300 for detecting an O-RAN element which causes timing drift according to an embodiment.

At operation 301, the RU receives at least one FH packet comprising TOD from the DU. According to embodiments, the DU may firstly formed the FH packet by using an eCPRI protocol including the TOD (e.g., using a structure that is the same or similar to the one illustrated in FIG. 2). After forming, the DU may send the FH packet to the RU.

At operation 302, the RU may detect the timing drift in FH based on the received at least one FH packet. According to embodiments, the RU may determine whether a SFN of the FH packet received from the DU matches with a SFN derived by the RU. It may be detected that there is timing drift based on determining that the SFN of the FH packet received from the DU is different from the SFN derived by the RU.

At operation 303, the RU may identify the O-RAN element which causes the timing drift based on determining the timing drift.

According to embodiments, a plurality of synchronization plane (s-plane) parameters may be determined by the RU. Particularly, the s-plane parameters may include a timestamp carried in a Precision Time Protocol (PTP) event packet, and a clock status carried in a PTP general packet. The O-RAN element which causes the timing drift may include, but are not limited to, one of the RU, the DU, and the transport network.

The RU may firstly compare the TOD in the at least one FH packet received from the DU with a TOD available with the RU. Although it may be possible to conclude the O-RAN element which causes the timing drift based on the comparison of the TOD, according to embodiments, a further check can be made using the s-plane parameters or the s-plane status of the RU to identify the O-RAN element which causes the timing drift.

Particularly, if it is determined that the TOD in FH packet received from the DU does not match with a TOD available with the RU, although it may be possible to conclude that the RU is responsible for causing the timing drift, it may also be determined as to whether the s-plane status of the RU indicates anomalies. If there are anomalies, it may be identified that the RU is responsible for causing the timing drift. For example, an anomaly may be determined based on a combination of S plane lock status and/or delay/offsets calculated by the S plane, as well as any S plane alarms/events which indicate an issue has occurred.

Conversely, if the TOD in the at least one FH packet received from the DU matches with a TOD available with the RU, although it may be possible to conclude that the DU or a transport network element is responsible for causing the timing drift, it may also be determined as to whether the plurality of s-plane parameters indicates any anomalies, and if there are no anomalies, it may be identified that the DU or an element in the transport network is responsible for causing the timing drift. For example, the element in the transport network which is responsible may be a switch or a router.

According to embodiments, the above method 300 may be implemented in a system such as a Radio Access Network (RAN), including, but are not limited to, a RU, DU, Control Unit (CU), and other network elements as appropriate.

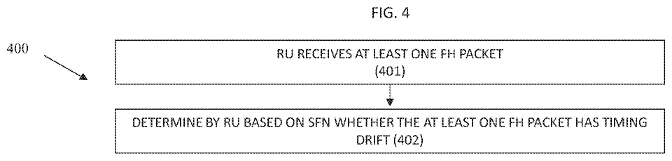

FIG. 4 illustrates a flowchart of a method 400 for analyzing timing drift based on a sub-frame number (SFN) according to an embodiment.

At operation 401, the RU may receive at least one FH packet. The FH packet may originate from the DU and includes Time of Day (TOD). The FH packet may use an eCPRI protocol (e.g., the same or similar to the one illustrated in FIG. 2 above).

At operation 402, the RU may determine based on a sub-frame number (SFN) as to whether the at least one FH packet has timing drift. This may include determining, by the RU, whether a sub-frame number (SFN) of the FH packet received from the DU matches with a SFN derived by the RU.

Based on the result in operation 402, upon determining that the SFN of the FH packet does not match the derived SFN, the RU may send a notification indicating that there is a timing drift coming from the DU. Alternatively, if it does match, the RU may simply indicate that there is a timing drift, without necessarily concluding what element is causing the timing drift.

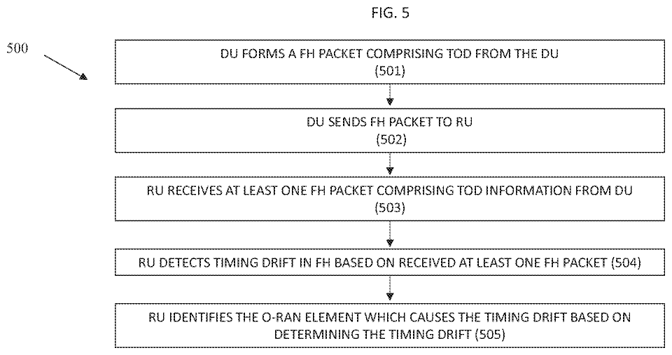

FIG. 5 illustrates a flowchart of a method 500 for detecting an O-RAN element which causes timing drift including forming a fronthaul (FH) packet according to an embodiment. It should be noted that operations 503, 504, and 505 are similar to operations 301, 302, and 303 respectively described with respect to FIG. 3 above, so redundant descriptions may be omitted for improved readability.

At operation 501, the DU forms a FH packet comprising TOD from the DU. According to embodiments, the FH packet may be formed using a format in accordance with the eCPRI message illustrated in FIG. 2.

At operation 502, the DU sends the FH packet formed in operation 501 to the RU.

At operation 503, the RU receives at least one FH packet comprising TOD from the DU.

At operation 504, the RU may detect the timing drift in FH based on the received at least one FH packet.

At operation 505, the RU may identify the O-RAN element which causes the timing drift based on determining the timing drift. Based on the above embodiments, it can be understood that adding TOD to fronthaul (FH) packets allow for analysis and debugging of timing drift issues in FH packets since the RU otherwise would not typically have TOD as a reference. This may be especially useful since in O-RAN different units (e.g., the DU and RU) may be from different vendors, so interoperability between different devices may be improved by adding the TOD to the FH packets.

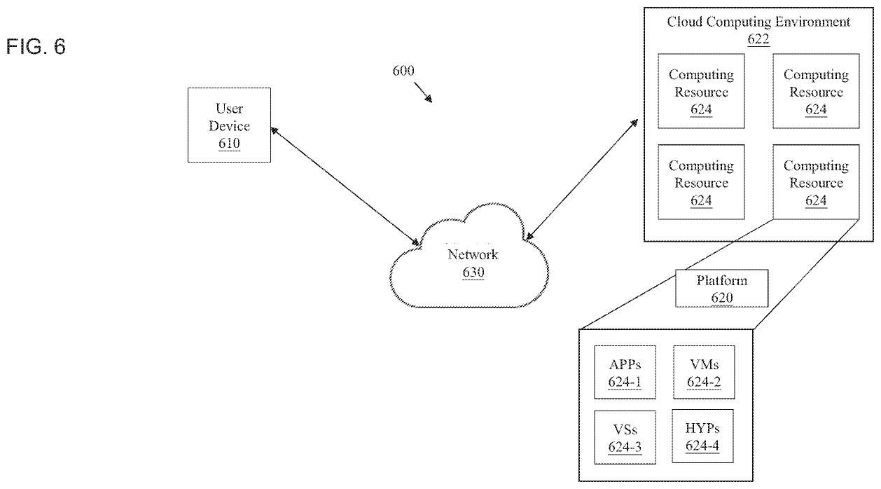

FIG. 6 is a diagram of an example environment 600 in which systems and/or methods, described herein, may be implemented. As shown in FIG. 6, environment 600 may include a user device 610, a platform 620, and a network 630. Devices of environment 600 may interconnect via wired connections, wireless connections, or a combination of wired and wireless connections. In embodiments, any of the functions and operations described with reference to FIGS. 2 through 5 above may be performed by any combination of elements illustrated in FIG. 6.

User device 610 includes one or more devices capable of receiving, generating, storing, processing, and/or providing information associated with platform 620. For example, user device 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 610 may receive information from and/or transmit information to platform 620.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc., services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components (e.g., nodes, E2 nodes, SMO functions, RIC, system, apparatus, etc.) may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 includes one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

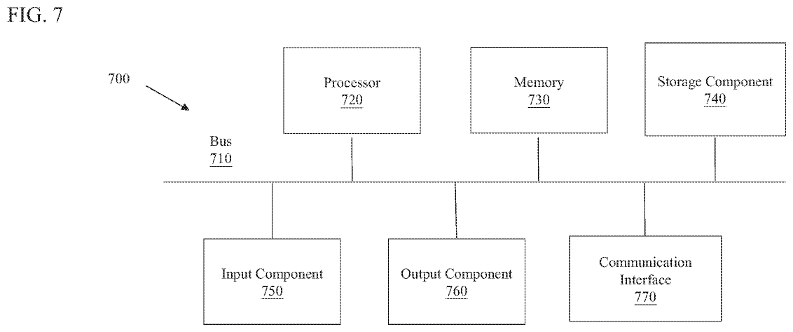

FIG. 7 is a diagram of example components of a device 700. Device 700 may correspond to user device 610 and/or platform 620. As shown in FIG. 7, device 700 may include a bus 710, a processor 720, a memory 730, a storage component 740, an input component 750, an output component 760, and a communication interface 770.

Bus 710 includes a component that permits communication among the components of device 700. Processor 720 may be implemented in hardware, firmware, or a combination of hardware and software. Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 includes one or more processors capable of being programmed to perform a function. Memory 730 includes a random access memory (RAM), a read only memory (ROM), and/or another type of dynamic or static storage device (e.g., a flash memory, a magnetic memory, and/or an optical memory) that stores information and/or instructions for use by processor 720.

Storage component 740 stores information and/or software related to the operation and use of device 700. For example, storage component 740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 750 includes a component that permits device 700 to receive information, such as via user input (e.g., a touch screen display, a keyboard, a keypad, a mouse, a button, a switch, and/or a microphone). Additionally, or alternatively, input component 750 may include a sensor for sensing information (e.g., a global positioning system (GPS) component, an accelerometer, a gyroscope, and/or an actuator). Output component 760 includes a component that provides output information from device 700 (e.g., a display, a speaker, and/or one or more light-emitting diodes (LEDs)).

Communication interface 770 includes a transceiver-like component (e.g., a transceiver and/or a separate receiver and transmitter) that enables device 700 to communicate with other devices, such as via a wired connection, a wireless connection, or a combination of wired and wireless connections. Communication interface 770 may permit device 700 to receive information from another device and/or provide information to another device. For example, communication interface 770 may include an Ethernet interface, an optical interface, a coaxial interface, an infrared interface, a radio frequency (RF) interface, a universal serial bus (USB) interface, a Wi-Fi interface, a cellular network interface, or the like.

Device 700 may perform one or more processes described herein. Device 700 may perform these processes in response to processor 720 executing software instructions stored by a non-transitory computer-readable medium, such as memory 730 and/or storage component 740. A computer-readable medium is defined herein as a non-transitory memory device. A memory device includes memory space within a single physical storage device or memory space spread across multiple physical storage devices.

Software instructions may be read into memory 730 and/or storage component 740 from another computer-readable medium or from another device via communication interface 770. When executed, software instructions stored in memory 730 and/or storage component 740 may cause processor 720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

In embodiments, any of the operations or processes of FIGS. 2-5 may be implemented by or using any one of the elements illustrated in FIGS. 6 and 7. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

These computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### VARIOUS ASPECTS OF EMBODIMENTS

Various further respective aspects and features of embodiments of the present disclosure may be defined by the following items:

Item [1]: A method including: receiving, by a radio unit (RU) in an Open Radio Access Network (O-RAN) network, at least one fronthaul (FH) packet including a Time of Day (TOD) from a distributed unit (DU) in the O-RAN network; detecting, by the RU, a timing drift in fronthaul (FH) based on the received at least one FH packet; and identifying, by the RU, at least one O-RAN element in the O-RAN network causing the timing drift in FH based on detecting the timing drift.

Item [2]: The method according to item [1], wherein receiving the at least one fronthaul (FH) packet includes: forming, by the DU, a FH packet including the TOD from the DU; and sending, by the DU, the FH packet to the RU.

Item [3]: The method according to any one of items [1]-[2], wherein detecting the timing drift includes: comparing, by the RU, a sub-frame number (SFN) of the FH packet received from the DU with a SFN derived by the RU; and determining, by the RU, that there is timing drift based on determining that the SFN of the FH packet received from the DU is different from the SEN derived by the RU.

Item [4]: The method according to any one of items [1]-[3], wherein identifying the at least one O-RAN element causing the timing drift in FH includes: comparing whether the TOD in the at least one FH packet received from the DU matches with a TOD available with the RU; and determining, by the RU, a plurality of synchronization plane (s-plane) parameters, wherein the at least one O-RAN element includes one of the RU, the DU and a transport network, and wherein the plurality of s-plane parameters includes at least one of a timestamp carried in a Precision Time Protocol (PTP) event packet, and a clock status carried in a PTP general packet.

Item [5]: The method according to item [4], wherein identifying the at least one O-RAN element causing the timing drift in FH further includes: if the TOD in the at least one FH packet received from the DU does not match with the TOD available with the RU, determining whether a s-plane status of the RU indicates any anomalies; and if determined that the s-plane status of the RU indicates anomalies, identifying that the RU is responsible for causing the timing drift.

Item [6]: The method according to item [4], wherein identifying the at least one O-RAN element causing the timing drift in FH further includes: if the TOD in the at least one FH packet received from the DU matches with the TOD available with the RU, determining whether the plurality of s-plane parameters indicates any anomalies; and if determined that the plurality of s-plane parameters do not indicate any anomalies, identifying that the DU or the transport network is responsible for causing the timing drift, wherein the transport network includes at least one of a switch and a router.

Item [7]: The method according to any one of items [1]-[6], wherein the at least one FH packet is in a format for an Evolved Common Public Radio Interface (eCPRI) protocol.

Item [8]. A system implemented in a radio access network (RAN) including: a radio unit (RU); a distributed unit (DU); and at least one transport network element; wherein the RU is configured to receive at least one fronthaul (FH) packet including a Time of Day (TOD) information from the DU, detect a timing drift in fronthaul (FH) based on the received at least one FH packet, and identify at least one of the RU, the DU, or the at least one transport network element as causing the timing drift in FH based on detecting the timing drift.

Item [9]: The system according to item [8], wherein the DU is configured to form a FH packet including the TOD from the DU and send the FH packet to the RU.

Item [10]: The system according to any one of items [8]-[9], wherein the RU is further configured to detect the timing drift by: comparing a sub-frame number (SFN) of the FH packet received from the DU with a SFN derived by the RU; and determining that there is timing drift based on determining that the SFN of the FH packet received from the DU is different from the SFN derived by the RU.

Item [11]: The system according to any one of items [8]-[10], wherein the RU is further configured to identify at least one of the RU, the DU, or the at least one transport network element as causing the timing drift in FH by: comparing whether the TOD in the at least one FH packet received from the DU matches with a TOD available with the RU; and determining a plurality of synchronization plane (s-plane) parameters, wherein the plurality of s-plane parameters includes at least one of a timestamp carried in a Precision Time Protocol (PTP) event packet, and a clock status carried in a PTP general packet.

Item [12]: The system according to item [11], wherein the RU is further configured to identify at least one of the RU, the DU, or the at least one transport network element as causing the timing drift in FH by: if the TOD in the at least one FH packet received from the DU does not match with a TOD available with the RU, determining whether a s-plane status of the RU indicates any anomalies; and if determined that s-plane status of the RU indicates anomalies, identifying that the RU is responsible for causing the timing drift.

Item [13]: The system according to item [11], wherein the RU is further configured to identify at least one of the RU, the DU, or the at least one transport network element as causing the timing drift in FH by: if the TOD in the at least one FH packet received from the DU matches with a TOD available with the RU, determining whether the plurality of s-plane parameters indicates any anomalies; and if determined that the plurality of s-plane parameters do not indicate any anomalies, identifying that the DU or the transport network is responsible for causing the timing drift, wherein the at least one transport network element includes at least one of a switch and a router.

Item [14]: The system according to any one of items [8]-[13], wherein the at least one FH packet is in a format for an Evolved Common Public Radio Interface (eCPRI) protocol.

Item [15]: A non-transitory computer-readable recording medium having recorded thereon instructions to perform a method including: receiving, by a radio unit (RU) in an Open Radio Access Network (O-RAN) network, at least one fronthaul (FH) packet including a Time of Day (TOD) from a distributed unit (DU) in the O-RAN network; detecting, by the RU, a timing drift in fronthaul (FH) based on the received at least one FH packet; and identifying, by the RU, at least one O-RAN element in the O-RAN network causing the timing drift in FH based on detecting the timing drift.

Item [16]: The non-transitory computer-readable recording medium according to item [15], wherein receiving the at least one fronthaul (FH) packet includes: forming, by the DU, a FH packet comprising the TOD from the DU; and sending, by the DU, the FH packet to the RU.

Item [17]: The non-transitory computer-readable recording medium according to any one of items [15]-[16], wherein detecting the timing drift includes: comparing, by the RU, a sub-frame number (SFN) of the FH packet received from the DU with a SFN derived by the RU; and

determining, by the RU, that there is timing drift based on determining that the SEN of the FH packet received from the DU is different from the SFN derived by the RU.

Item [18]: The non-transitory computer-readable recording medium according to any one of items [15]-[17], wherein identifying the at least one O-RAN element causing the timing drift in FH includes: comparing whether the TOD in the at least one FH packet received from the DU matches with a TOD available with the RU; and determining, by the RU, a plurality of synchronization plane (s-plane) parameters, wherein the at least one O-RAN element comprises one of the RU, the DU and a transport network, and wherein the plurality of s-plane parameters includes at least one of a timestamp carried in a Precision Time Protocol (PTP) event packet, and a clock status carried in a PTP general packet.

Item [19]: The non-transitory computer-readable recording medium according to item [18], wherein identifying the at least one O-RAN element causing the timing drift in FH further includes: if the TOD in the at least one FH packet received from the DU does not match with the TOD available with the RU, determining whether a s-plane status of the RU indicates any anomalies; and if determined that the s-plane status of the RU indicates anomalies, identifying that the RU is responsible for causing the timing drift.

Item [20]: The non-transitory computer-readable recording medium according to item [18], wherein identifying the at least one O-RAN element causing the timing drift in FH further includes: if the TOD in the at least one FH packet received from the DU matches with the TOD available with the RU, determining whether the plurality of s-plane parameters indicates any anomalies; and if determined that the plurality of s-plane parameters do not indicate any anomalies, identifying that the DU or the transport network is responsible for causing the timing drift, wherein the transport network comprises at least one of a switch and a router.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by a radio unit (RU) in an Open Radio Access Network (O-RAN) network, at least one fronthaul (FH) packet comprising a Time of Day (TOD) from a distributed unit (DU) in the O-RAN network;
detecting, by the RU, a timing drift in fronthaul (FH) based on the received at least one FH packet; and
identifying, by the RU, at least one O-RAN element in the O-RAN network causing the timing drift in FH based on detecting the timing drift.

2. The method as claimed in claim 1, wherein receiving the at least one fronthaul (FH) packet comprises:
forming, by the DU, a FH packet comprising the TOD from the DU; and
sending, by the DU, the FH packet to the RU.

3. The method as claimed in claim 1, wherein detecting the timing drift comprises:
comparing, by the RU, a sub-frame number (SFN) of the FH packet received from the DU with a SFN derived by the RU; and
determining, by the RU, that there is timing drift based on determining that the SFN of the FH packet received from the DU is different from the SEN derived by the RU.

4. The method as claimed in claim 1, wherein identifying the at least one O-RAN element causing the timing drift in FH comprises:
comparing whether the TOD in the at least one FH packet received from the DU matches with a TOD available with the RU; and
determining, by the RU, a plurality of synchronization plane (s-plane) parameters, wherein the at least one O-RAN element comprises one of the RU, the DU and a transport network, and wherein the plurality of s-plane parameters includes at least one of a timestamp carried in a Precision Time Protocol (PTP) event packet, and a clock status carried in a PTP general packet.

5. The method as claimed in claim 4, wherein identifying the at least one O-RAN element causing the timing drift in FH further comprises:
if the TOD in the at least one FH packet received from the DU does not match with the TOD available with the RU, determining whether a s-plane status of the RU indicates any anomalies; and
if determined that the s-plane status of the RU indicates anomalies, identifying that the RU is responsible for causing the timing drift.

6. The method as claimed in claim 4, wherein identifying the at least one O-RAN element causing the timing drift in FH further comprises:
if the TOD in the at least one FH packet received from the DU matches with the TOD available with the RU, determining whether the plurality of s-plane parameters indicates any anomalies; and
if determined that the plurality of s-plane parameters do not indicate any anomalies, identifying that the DU or the transport network is responsible for causing the timing drift, wherein the transport network comprises at least one of a switch and a router.

7. The method as claimed in claim 1, wherein the at least one FH packet is in a format for an Evolved Common Public Radio Interface (eCPRI) protocol.

8. A system implemented in a radio access network (RAN) comprising:
a radio unit (RU);
a distributed unit (DU); and
at least one transport network element;
wherein the RU is configured to receive at least one fronthaul (FH) packet comprising a Time of Day (TOD) information from the DU, detect a timing drift in fronthaul (FH) based on the received at least one FH packet, and identify at least one of the RU, the DU, or the at least one transport network element as causing the timing drift in FH based on detecting the timing drift.

9. The system as claimed in claim 8, wherein the DU is configured to form a FH packet comprising the TOD from the DU and send the FH packet to the RU.

10. The system as claimed in claim 8, wherein the RU is further configured to detect the timing drift by:
comparing a sub-frame number (SFN) of the FH packet received from the DU with a SFN derived by the RU; and
determining that there is timing drift based on determining that the SFN of the FH packet received from the DU is different from the SFN derived by the RU.

11. The system as claimed in claim 8, wherein the RU is further configured to identify at least one of the RU, the DU, or the at least one transport network element as causing the timing drift in FH by:
comparing whether the TOD in the at least one FH packet received from the DU matches with a TOD available with the RU; and
determining a plurality of synchronization plane (s-plane) parameters, wherein the plurality of s-plane parameters includes at least one of a timestamp carried in a Precision Time Protocol (PTP) event packet, and a clock status carried in a PTP general packet.

12. The system as claimed in claim 11, wherein the RU is further configured to identify at least one of the RU, the DU, or the at least one transport network element as causing the timing drift in FH by:
if the TOD in the at least one FH packet received from the DU does not match with a TOD available with the RU, determining whether a s-plane status of the RU indicates any anomalies; and
if determined that s-plane status of the RU indicates anomalies, identifying that the RU is responsible for causing the timing drift.

13. The system as claimed in claim 11, wherein the RU is further configured to identify at least one of the RU, the DU, or the at least one transport network element as causing the timing drift in FH by:
if the TOD in the at least one FH packet received from the DU matches with a TOD available with the RU, determining whether the plurality of s-plane parameters indicates any anomalies; and
if determined that the plurality of s-plane parameters do not indicate any anomalies, identifying that the DU or the transport network is responsible for causing the timing drift, wherein the at least one transport network element comprises at least one of a switch and a router.

14. The system as claimed in claim 8, wherein the at least one FH packet is in a format for an Evolved Common Public Radio Interface (eCPRI) protocol.

15. A non-transitory computer-readable recording medium having recorded thereon instructions to perform a method comprising:
receiving, by a radio unit (RU) in an Open Radio Access Network (O-RAN) network, at least one fronthaul (FH) packet comprising a Time of Day (TOD) from a distributed unit (DU) in the O-RAN network;
detecting, by the RU, a timing drift in fronthaul (FH) based on the received at least one FH packet; and
identifying, by the RU, at least one O-RAN element in the O-RAN network causing the timing drift in FH based on detecting the timing drift.

16. The non-transitory computer-readable recording medium as claimed in claim 15, wherein receiving the at least one fronthaul (FH) packet comprises:
forming, by the DU, a FH packet comprising the TOD from the DU; and
sending, by the DU, the FH packet to the RU.

17. The non-transitory computer-readable recording medium as claimed in claim 15, wherein detecting the timing drift comprises:
comparing, by the RU, a sub-frame number (SFN) of the FH packet received from the DU with a SFN derived by the RU; and
determining, by the RU, that there is timing drift based on determining that the SFN of the FH packet received from the DU is different from the SFN derived by the RU.

18. The non-transitory computer-readable recording medium as claimed in claim 15, wherein identifying the at least one O-RAN element causing the timing drift in FH comprises:
comparing whether the TOD in the at least one FH packet received from the DU matches with a TOD available with the RU; and
determining, by the RU, a plurality of synchronization plane (s-plane) parameters, wherein the at least one O-RAN element comprises one of the RU, the DU and a transport network, and wherein the plurality of s-plane parameters includes at least one of a timestamp carried in a Precision Time Protocol (PTP) event packet, and a clock status carried in a PTP general packet.

19. The non-transitory computer-readable recording medium as claimed in claim 18, wherein identifying the at least one O-RAN element causing the timing drift in FH further comprises:
if the TOD in the at least one FH packet received from the DU does not match with the TOD available with the RU, determining whether a s-plane status of the RU indicates any anomalies; and
if determined that the s-plane status of the RU indicates anomalies, identifying that the RU is responsible for causing the timing drift.

20. The non-transitory computer-readable recording medium as claimed in claim 18, wherein identifying the at least one O-RAN element causing the timing drift in FH further comprises:
if the TOD in the at least one FH packet received from the DU matches with the TOD available with the RU, determining whether the plurality of s-plane parameters indicates any anomalies; and
if determined that the plurality of s-plane parameters do not indicate any anomalies, identifying that the DU or the transport network is responsible for causing the timing drift, wherein the transport network comprises at least one of a switch and a router.
